(19) United States
(12) Patent Application Publication
(10) Pub. No.: US 2013/0133469 A1
(43) Pub. Date: May 30, 2013

(54) SIDESTICK CONTROLLER GRIP

(71) Applicants: Hans Jorg REY, Sao Jose dos Campos-SP (BR); Luiz Fernando Silva de CASTRO PAIVA, Sao Jose dos Campos - SP (BR); Celso Aparecido Cruz GUEIROS, Sao Jose dos Campos - SP (BR); Rogério de CERQUEIRA LARIO, Sao Jose dos Campos - SP (BR); Bruno Kimura CASTANHA, Sao Jose dos Campos - SP (BR)

(72) Inventors: Hans Jorg REY, Sao Jose dos Campos-SP (BR); Luiz Fernando Silva de CASTRO PAIVA, Sao Jose dos Campos - SP (BR); Celso Aparecido Cruz GUEIROS, Sao Jose dos Campos - SP (BR); Rogério de CERQUEIRA LARIO, Sao Jose dos Campos - SP (BR); Bruno Kimura CASTANHA, Sao Jose dos Campos - SP (BR)

(73) Assignee: EMBRAER S.A., Sao Jose dos Campos - SP (BR)

(21) Appl. No.: 13/305,721

(22) Filed: Nov. 28, 2011

(51) Int. Cl. G05G 1/06

(52) U.S. Cl. 74/558.5

(57) ABSTRACT

Sidestick controller grips are provided with a base, an elongate column grip extending upwardly from the base, a head at an upper end portion of the grip column, and a thumb rest surface extending laterally and upwardly relative to the column grip. The thumb rest surface may be supported by a concave outwardly extending support wall which joins the thumbrest surface at a generally serpentine edge which may extend generally outwardly convexly from a lower region thereof at the column grip to a convex apex region, and then extends from the apex region generally upwardly and concavely to an upper region thereof at the head.

### CROSS-REFERENCE

This application is related to commonly owned U.S. Design application Ser. No. 29/______ (Atty. Dkt. No. BHD-4439-113) filed concurrently herewith, the entire content of such application being hereby expressly incorporated hereinto by reference in its entirety.

### FIELD

The embodiments disclosed herein relate generally to sidestick controller grips which are usefully provided as an operator interface for a variety of apparatus so as to allow an operator to effect various manual control inputs.

### BACKGROUND

Sidestick controllers (more simply known in the art as “sidesticks” or “joysticks”) have been widely used in various industries for control of heavy machinery, construction vehicles, bulldozers, submarines, simulators and of course aircraft. The introduction of sidesticks within the aerospace industry has occurred primarily for military applications, such as to provide pilot control inputs for jet fighters, helicopters, aircraft simulators and remote-controlled (drone) aircraft. Furthermore, both commercial and general aviation industries have realized the advantages of replacing conventional centrally mounted control yokes with sidesticks to provide enhanced visibility of instruments in an aircraft instrument panel as well as increased physical space for the pilots. The use of sidesticks in aviation industries other than military aviation was thus only feasible when the fly-by-wire technology of military aircraft became available for non-military aircraft.

One of the most challenging aspects that engineers and designers face when developing sidesticks for non-military aircraft resides with providing the proper ergonomic characteristics for such sidesticks since their locations in relation to the pilots and the force magnitudes are significantly different when compared to the well-known aircraft control yokes. More specifically, as its name implies, a sidestick is located physically at the lateral console of the aircraft and is intended to be commanded by only one arm of the pilot while a control yoke is located physically in front of the pilot and may be commanded readily by both arms. Consequently, the break-out force and master gradient in sidesticks are significantly lower as compared to conventional control yokes.

Equally important for achieving a harmonic application of sidesticks in terms of ergonomics and handling quality are the comfort and accessibility of important system functions actuators, such as auto-pilot quick disconnect function, priority of control (i.e. take priority of control for the on-side sidestick while the cross-side sidestick is inactive), PTT (push-to-talk) communication functions, and the like. The sidestick controller grips as disclosed herein are therefore directed to providing superior ergonomics and handling quality in terms of operator comfort and accessibility for various system functions.

### SUMMARY

According to one aspect, sidestick controller grips will comprise a base, an elongate column grip extending upwardly from the base, a head at an upper end portion of the grip column, and a thumb rest surface extending laterally and upwardly relative to the column grip. The thumb rest surface may be supported by a concave outwardly extending support wall which joins the thumbrest surface at a generally serpentine edge. In this regard, the generally serpentine edge may extend generally outwardly convexly from a lower region thereof at the column grip to a convex apex region, and then extends from the apex region generally upwardly and concavely to an upper region thereof at the head. The thumbrest surface may be concave to facilitate comfort.

The head of the sidestick controller grip may include a split face surface defining inboard and outboard face surfaces disposed laterally adjacent to one another. According to some embodiments, the inboard face surface is disposed at an elevation that is lower than the outboard face surface. Inboard and outboard pushbuttons may thus project outwardly from the inboard and outboard face surfaces, respectively. More specifically, some embodiments will include an inboard face surface which is disposed at an elevation that is lower than the outboard face surface so that the inboard pushbutton is positioned in an inboard recessed well defined by the inboard face surface and an L-shaped pair of top and side walls. The inboard and outboard face surfaces may be joined to one another at an aft end thereof, and forwardly diverge relative to one another such that the inboard face surface is at a lower elevation as compared to the outboard face surface.

A forward pushbutton and/or a lateral pushbutton may extend outwardly from the head and laterally from the thumbrest support wall to provide ready pilot control of other aircraft system functions

Some embodiments of the sidestick controller grip will comprise an elastomeric material covering at lest a portion of the column grip. The base may also include a concavely flared palm support surface that can be elongated in an aft direction.

Other embodiment of the sidestick controller grip will comprise a base, an elongate column grip extending upwardly from the base, and a head at an upper end portion of the grip column, wherein the head includes a split face surface defining inboard and outboard face surfaces disposed laterally adjacent to one another with the inboard face surface being at an elevation which is lower than the outboard face surface. Inboard and outboard pushbuttons may thus be provided which project outwardly from the inboard and outboard face surfaces, respectively.

Aircraft or other apparatus requiring manual user control inputs (e.g., heavy machinery, system simulators and the like) may thus be provided with one (or more) sidestick controller grips. When provided in an aircraft, a mirror image pair of sidestick controller grips will likely be present, one being a left-handed grip for the pilot and one being a right-handed grip for the co-pilot.

These and other aspects and advantages will become more clear after careful consideration is given to the following detailed description of the preferred exemplary embodiments thereof.

### BRIEF DESCRIPTION OF ACCOMPANYING DRAWINGS

The disclosed embodiments will be better and more completely understood by referring to the following detailed description of exemplary non-limiting illustrative embodiments in conjunction with the drawings of which:

FIG. 1 is a pilot's eye view of an aircraft cockpit in which pilot (left-handed) and co-pilot (right-handed) sidestick controller grips according to one embodiment are provided;

FIG. 2 is a right-side perspective view of the pilot (left-handed) sidestick controller grip depicted in FIG. 1;

FIGS. 3 and 4 are front and rear elevational views, respectively, of the sidestick controller grip depicted in FIG. 2;

FIG. 5 is a top plan view of the sidestick controller grip depicted in FIG. 2;

FIGS. 6 and 7 are right and left side elevational views, respectively, of the sidestick controller grip depicted in FIG. 2; and

FIGS. 8 and 9 are front and rear elevational views of a sidestick controller according to another embodiment.

### DETAILED DESCRIPTION

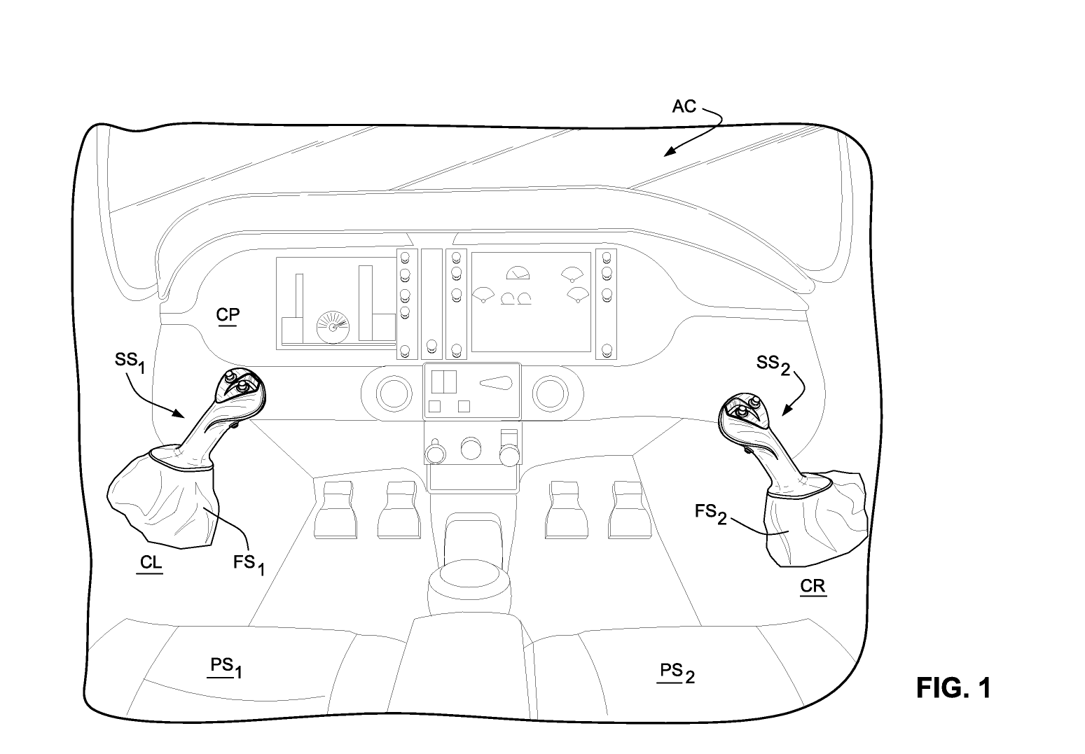

Accompanying FIG. 1 depicts a pilots-eye view of an exemplary aircraft cockpit AC environment in which the aircraft controls and instrumentation are located. As can be seen, pilot (left-handed) and copilot (right-handed) sidestick controller grips SS1 and SS2 (hereinafter sometimes more simply referred to as “sidesticks”) are positioned on the lateral left and right consoles CL, CR of the cockpit AC adjacent the pilot and copilot seats PS1, PS2, respectively. A flexible shroud FS1, FS2 may be provided with each of the sidesticks SS1, SS2 so as to visibly hide the mechanical and electrical connections thereof. As can be seen, the control panel CP is unobstructed by the sidesticks SS1 and SS2 due to their positioning laterally of the seats PS1, PS2 on the consoles CL, CR, respectively, thereby providing the pilots with greater visibility of the aircraft instrumentation.

It will be understood that, while reference will be made to an aircraft sidestick controller, various other uses and apparatus may similarly be provided with a control stick as described herein. Thus, reverence to an aircraft sidestick controller is to be understood to be a reference to a presently preferred embodiment that is non-limiting to its possible end uses.

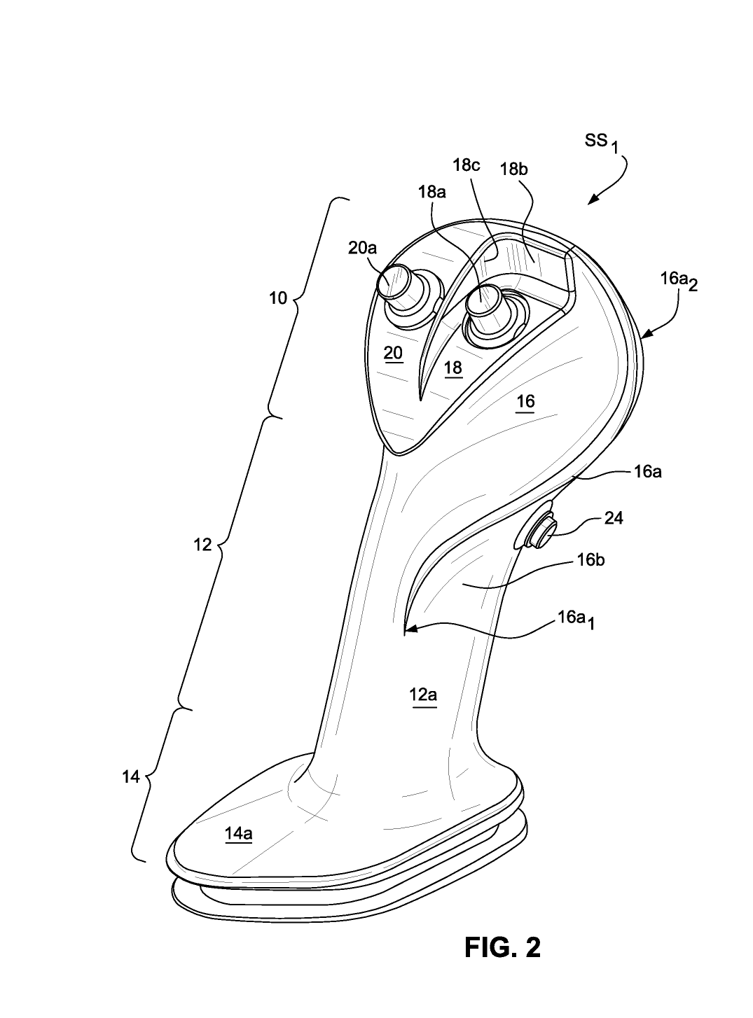

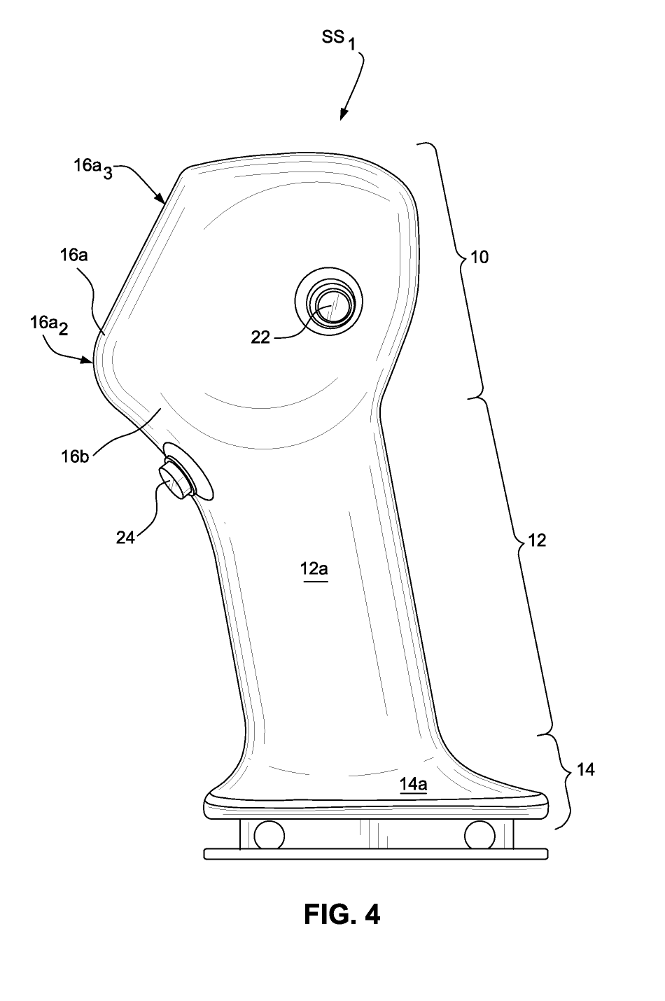

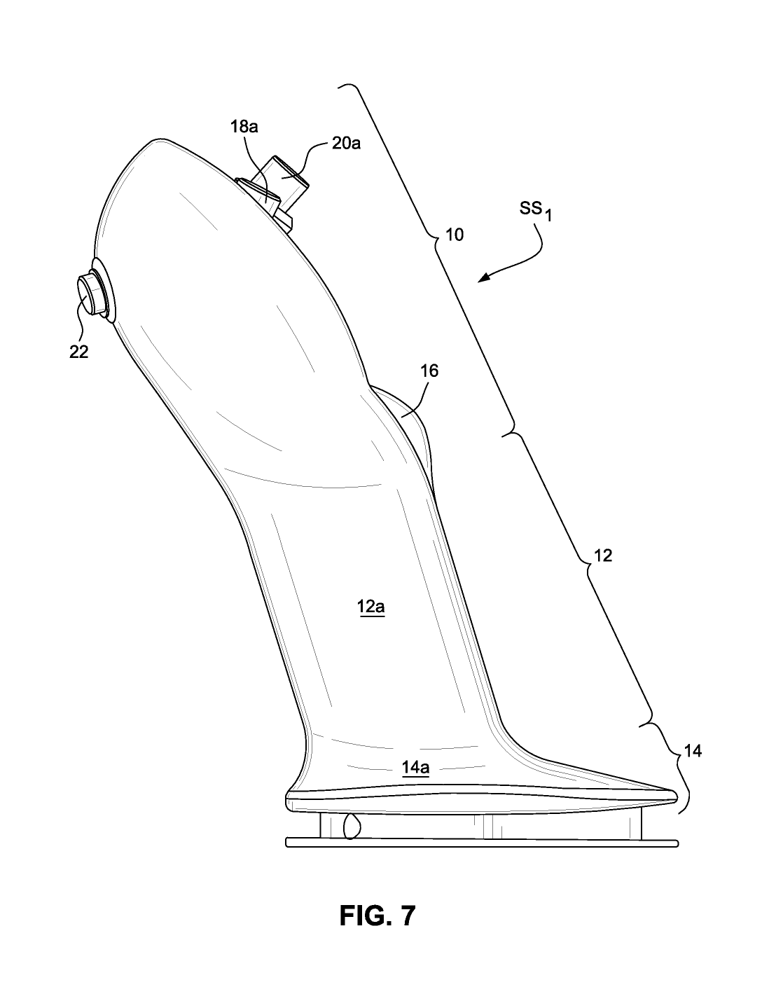

Accompanying FIGS. 2-7 depict in greater detail the pilot (left-handed) sidestick SS1, it being understood that the co-pilot (right-handed) sidestick SS2 is substantially a mirror image thereof. Thus, the discussion below with respect to the pilot sidestick SS1 is equally germane and pertinent to the co-pilot sidestick SS2 but will not be discussed in greater detail in the interest of clarity.

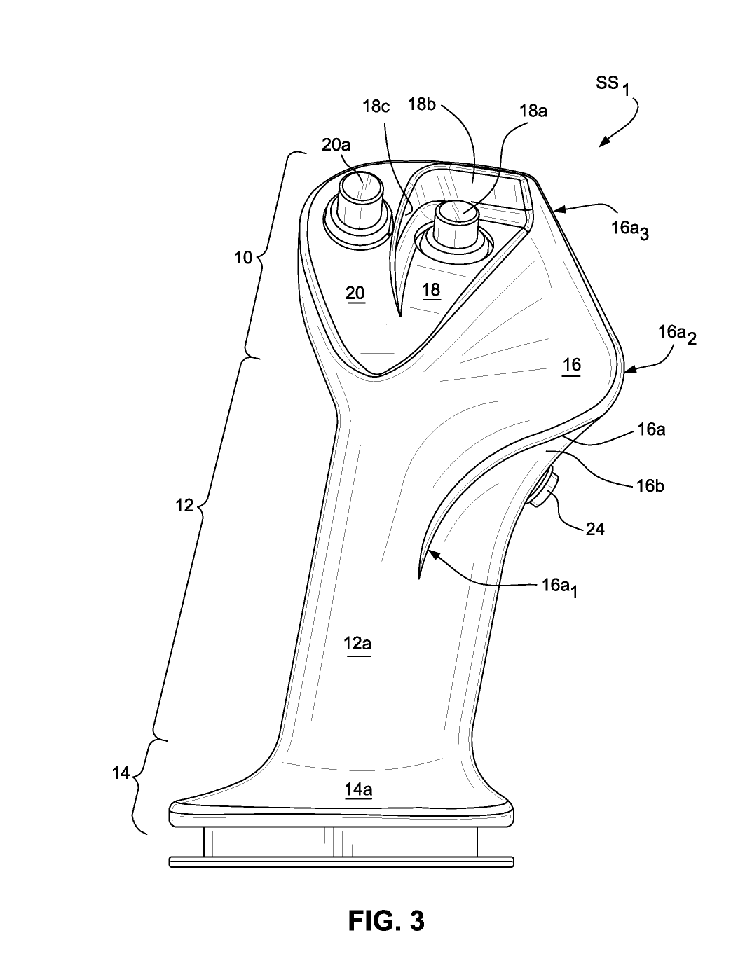

The sidestick SS1 is generally comprised of an upper head 10, a column grip 12 and a lower base 14 that are configured so that a pilot's left hand may comfortably fit thereon when the sidestick is gripped during use (see FIG. 2). A thumbrest surface 16 extends generally laterally outwardly and upwardly relative to the column grip 12. As shown, for example in FIG. 3, the thumbrest surface 16 is supported by a concave outwardly extending support wall 16b which joins the thumbrest surface at a lateral generally serpentine edge 16a. The edge 16a extends generally outwardly convexly from a lower region 16a₁ thereof at the column grip 12 to a convex apex region 16a₂ and then generally upwardly and concavely to an upper region 16a₃ thereof at the head 10. The thumbrest surface 16 is itself slightly concave so as to promote comfort.

The head 10 defines a split face surface defining slightly convex or substantially planar inboard and outboard (relative to the pilot) face surfaces 18, 20 disposed laterally adjacent to one another. The inboard and outboard surfaces 18, 20 are thus joined to one another at an aft end (relative to the control panel CP) thereof and then forwardly diverge from one another so the former is at an elevation that is lower relative to the latter. The inboard and outward surfaces 18, 20 include push buttons 18a, 20a protruding outwardly therefrom. The push button 18a may for example serve to provide quick disconnect of the auto-pilot and/or to establish priority of the sidesticks SS1 and SS2 (e.g., to establish which one of the sidesticks SS1 or SS2 is capable of providing active control inputs to the aircraft attitude control surfaces), while the push button 20a may be employed as a tactile control steering (TCS) pushbutton (e.g., to allow a pilot to override the autopilot momentarily without disengaging the autopilot to permit the input of manual pitch (vertical speed) changes). Thus, in order to allow a pilot more tactile sensation to identify the correct one of the push buttons 18a, 20a (and thereby minimize confusion as to which of the push buttons is being actuated), the inboard push button 18a is at a slightly lower elevation as compared to the outboard push button 20a due to the differential angular orientation of the respective face surfaces 18, 20.

In this regard, a plane tangent to each of the face surfaces 18, 20 is inclined generally upwardly and forwardly (relative to the control panel CP) at different angles. The angle of inclination of the inboard face surface 18 relative to a horizontal plane is less than that of the outboard face surface. Moreover, the angular difference relative to a horizontal plane between the inboard and outboard face surfaces 18, 20 is such that the planar top surfaces of the push buttons 18a, 20a extending outwardly from the face surfaces 18, 20, respectively, form an angle of therebetween of about 10° to about 15°, more preferably about 13° (±about 0.25°).

In use, a pilot will grasp the sidestick SS1 so that the pilot's palm is placed physically against the column grip 12 with the thumb positioned on and supported by the thumbrest surface 16. The pilot will then be capable of manipulating the thumb and fingers so as to access various system push buttons presented by the sidestick SS1. It will be observed in this regard that the inboard push button 18a is located essentially in an inboard recessed well defined by the face surface 18 and the L-shaped top and side walls 18b, 18c joining the lower inboard face wall 18 to the upper outboard face wall 20. As is seen, the side wall 18c tapers from its junction with the top wall 18b in an aft direction to the juncture of the inboard and outboard face surfaces 18, 20 so as to be generally triangularly shaped (although having a slight convexly arcuate configuration). The recessed well defined by the walls 18b, 18c is thus open on its inboard (pilot) side to allow the pilot's thumb to be moved easily from the thumbrest surface 16 for access and activation of the push button 18a. Similarly, the pilot's thumb may be suitably positioned to allow for access and activation of the push button 20a protruding from the outboard face surface 20, in which case the lower elevation of the inboard face surface 18 relative to the outboard face surface 20 provides the pilot with tactile feed-back of thumb positioning.

The sidestick SS1 also includes additional push buttons 22, 24. By way of example, the push button 22 may be provided as a push-to-talk (PTT) communication switch to allow radio communication when depressed, while the push button 24 may be provided as an enhanced vision switch (EVS) to allow the pilot to select enhanced vision (e.g., either synthetic vision or infrared vision) displayed on the instrumentation of the cockpit control panel CP. The push button 22 protrudes outwardly and forwarding (relative to the control panel CP) so as to be manipulated by the pilots index (second) finger. The push button 24 protrudes outwardly and laterally downwardly from the thumbrest support wall 16b so as to be manipulated by the pilot's middle (third) finger.

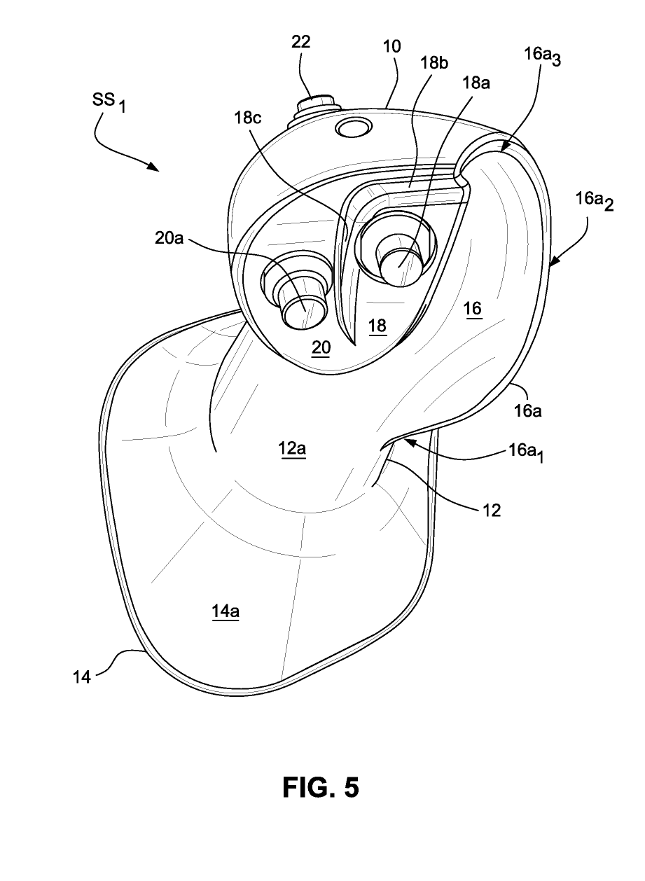

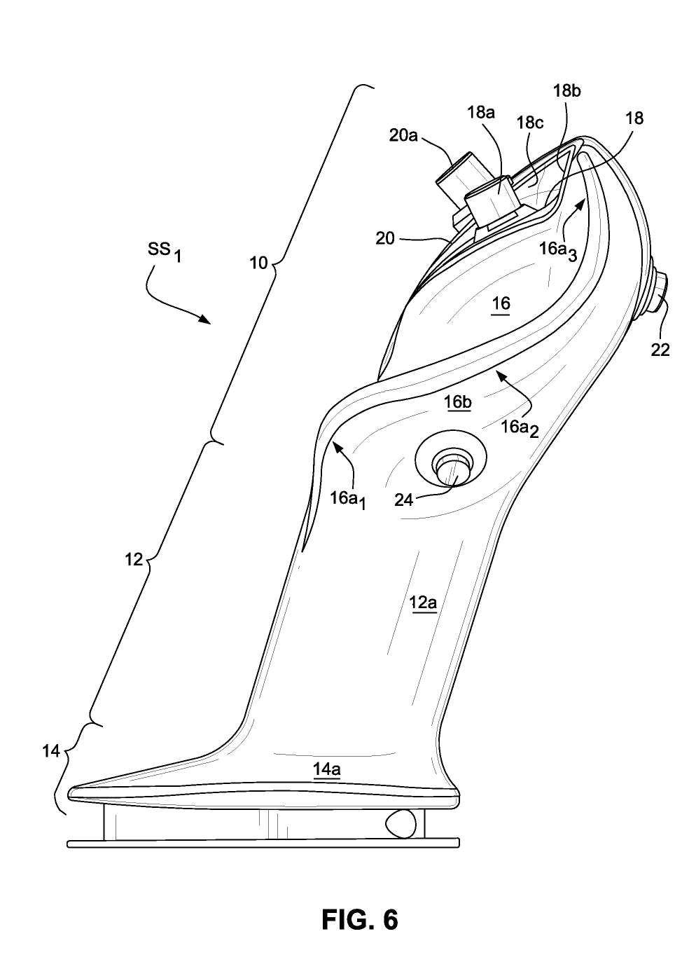

A lower concavely flared palm support surface 14a is provided at the lower base 14 so as to provide a palm rest for the pilot's hand. As shown, for example in FIGS. 5 and 6, the palm support surface 14a is elongated in the aft (relative to the control panel CP) direction so as to provide enhanced support for the pilot's palm when gripping the sidestick SS1.

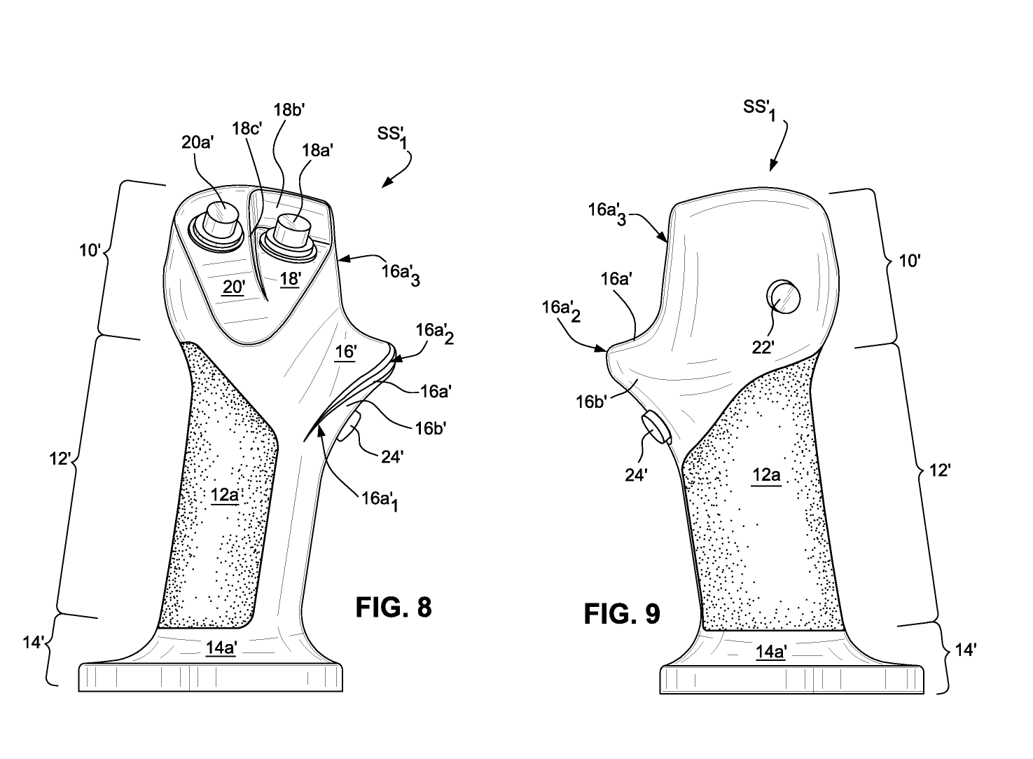

The external surface of the sidestick can be provided with any suitable tactile-enhancing material. By way of example, as shown by the embodiment depicted in FIGS. 8 and 9 (which include the same reference numerals as in FIGS. 2-7 but delineated by a prime (′) notation to illustrate similar structures therebetween), the column grip 12′ of the sidestick SS1′ may be provided with regions 12a in contact with a pilot's palm that are formed of a rubber-like elastomeric material to thereby provide enhanced gripping sensation. Alternatively, a metallized surface may be provided with or without surface roughness as may be desired.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope thereof.

What is claimed is:

1. A sidestick controller grip comprising a base, an elongate column grip extending upwardly from the base, a head at an upper end portion of the grip column, and a thumb rest surface extending laterally and upwardly relative to the column grip.

2. The sidestick controller grip as in claim 1, wherein the thumb rest surface is supported by a concave outwardly extending support wall.

3. The sidestick controller grip as in claim 2, wherein the support wall joins the thumbrest surface at a generally serpentine edge.

4. The sidestick controller grip as in claim 3, wherein the generally serpentine edge extends generally outwardly convexly from a lower region thereof at the column grip to a convex apex region, and then extends from the apex region generally upwardly and concavely to an upper region thereof at the head.

5. The sidestick controller grip as in claim 1, wherein the thumbrest surface is concave.

6. The sidestick controller grip as in claim 1, wherein the head includes a split face surface defining inboard and outboard face surfaces disposed laterally adjacent to one another.

7. The sidestick controller grip as in claim 6, wherein the inboard face surface is disposed at an elevation that is lower than the outboard face surface.

8. The sidestick controller grip as in claim 6, further comprising inboard and outboard pushbuttons projecting outwardly from the inboard and outboard face surfaces, respectively.

9. The sidestick controller grip as in claim 8, wherein the inboard face surface is disposed at an elevation that is lower than the outboard face surface so that the inboard pushbutton is positioned in an inboard recessed well defined by the inboard face surface and an L-shaped pair of top and side walls.

10. The sidestick controller grip as in claim 6, wherein the inboard and outboard face surfaces are joined to one another at an aft end thereof, and forwardly diverge relative to one another such that the inboard face surface is at a lower elevation as compared to the outboard face surface.

11. The sidestick controller grip as in claim 10, further comprising inboard and outboard pushbuttons projecting outwardly from the inboard and outboard face surfaces, respectively.

12. The sidestick controller grip as in claim 1 or 11, further comprising a forward pushbutton extending outwardly from the head.

13. The sidestick controller grip as in claim 2, further comprising a lateral pushbutton laterally from the thumbrest support wall.

14. The sidestick controller grip as in claim 1, further comprising an elastomeric material covering at lest a portion of the column grip.

15. The sidestick controller grip as in claim 1, wherein the base includes a concavely flared palm support surface.

16. The sidestick controller grip as in claim 1, wherein the palm support surface is elongated in an aft direction.

17. A sidestick controller grip comprising a base, an elongate column grip extending upwardly from the base, and a head at an upper end portion of the grip column, wherein the head includes a split face surface defining inboard and outboard face surfaces disposed laterally adjacent to one another with the inboard face surface being at an elevation which is lower than the outboard face surface.

18. The sidestick controller grip as in claim 17, further comprising inboard and outboard pushbuttons projecting outwardly from the inboard and outboard face surfaces, respectively.

19. The sidestick controller grip as in claim 17, further comprising a thumb rest surface extending laterally and upwardly relative to the column grip.

20. The sidestick controller grip as in claim 19, wherein the thumb rest surface is supported by a concave outwardly extending support wall.

21. The sidestick controller grip as in claim 20, wherein the support wall joins the thumbrest surface at a generally serpentine edge.

22. The sidestick controller grip as in claim 21, wherein the generally serpentine edge extends generally outwardly convexly from a lower region thereof at the column grip to a convex apex region, and then extends from the apex region generally upwardly and concavely to an upper region thereof at the head.

23. The sidestick controller grip as in claim 19, wherein the thumbrest surface is concave.

24. The sidestick controller grip as in claim 17, wherein the inboard and outboard face surfaces are joined to one another at an aft end thereof, and forwardly diverge relative to one another such that the inboard face surface is at a lower elevation as compared to the outboard face surface.

25. The sidestick controller grip as in claim 24, further comprising inboard and outboard pushbuttons projecting outwardly from the inboard and outboard face surfaces, respectively.

26. An aircraft which comprises a sidestick controller grip as in claim 1 or 17.
